(19) United States
(12) Patent Application Publication
(10) Pub. No.: US 2010/0033529 A1
(43) Pub. Date: Feb. 11, 2010

(54) PRINTING APPARATUS AND CONTROL METHOD OF THE SAME

(75) Inventor: Shintaro KOMURO, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/538,715

(22) Filed: Aug. 10, 2009

(30) Foreign Application Priority Data
Aug. 11, 2008 (JP) 2008-207225

(51) Int. Cl. B41J 29/38; B41J 2/01

(52) U.S. Cl. 347/16; 347/104

(57) ABSTRACT

Provided is a printing apparatus for performing a printing process on a printing surface of a printing medium, the printing apparatus including: a transport device which transports a transport object having the printing medium loaded thereon in a predetermined transport direction; and a transport object locking portion which locks a movement of the transport object at a predetermined position on the upstream side or the downstream side of the transport direction, wherein a skewed posture of the transport object with respect to the transport direction is corrected in the state where the transport object is locked by the transport object locking portion.

### BACKGROUND

1. Technical Field

The present invention relates to a printing apparatus which performs a printing process on a printing surface of a printing medium and a method of correcting a skewed posture of a transport object in the printing apparatus.

2. Related Art

Among printing apparatuses such as ink jet printers, there is generally known a printing apparatus which transports a transport object such as an exclusive tray (hereinafter, simply referred to as “a disc tray”) having an optical disc such as a CD (compact disc) or a DVD (digital versatile disc) loaded thereon by using a transport device and performs a printing process on a label surface of the optical disc. In this kind of printing apparatus, when the printing process is performed in the state where a posture of the disc tray with respect to a transport direction of the transport device is skewed (hereinafter, simply referred to as “a skew”), a positional deviation occurs between the label surface of the optical disc and a printing target position, which may deteriorate the printing precision. As an example of a known technology capable of preventing the deterioration in the printing precision with respect to the label surface of the optical disc caused by the skew, JP-A-2006-82323 discloses a printing apparatus including a device for correcting a skew of a disc tray.

However, in the device for correcting the skew of the disc tray disclosed in JP-A-2006-82323, guide members each having a wall surface substantially parallel to the transport direction are respectively provided on both sides of a transport path for a disc tray, and the guide members slidably engage with the disc tray by alternately repeating a normal transport operation of the disc tray and a reverse transport operation thereof using a transport device, thereby correcting the skew of the disc tray. In the known technology, a gap within at least manufacture tolerance is generally formed between the guide members and the disc tray. In addition, the guide members of the disc tray have to be disposed on the downstream side of a printing target region due to the general structure of the printing apparatus. Likewise, the shape, the arrangement, or the like of the guide member is limited in many cases. For this reason, in the known technology disclosed in JP-A-2006-82323, a problem arises in that the skew of the disc tray cannot be corrected with high precision.

Further, in many cases, the disc tray as a transport object is formed as a thin-plate-shaped member formed of, for example, plastic or the like. Generally, the disc tray is formed of a material harder than the printing medium such as a printing sheet. For this reason, generally, abrasion of a part (transport driving roller or the like) of the transport device caused by the case of transporting the disc tray tends to be considerably larger than that of the case of transporting the printing medium such as the printing sheet. Further, since the disc tray is repeatedly used, the disc tray is also abraded upon performing the transport operation using the transport device. For this reason, in the known technology for correcting the skew of the disc tray by alternately repeating the normal transport operation of the disc tray and the reverse transport operation thereof using the transport device, since the part of the transport device or the disc tray is rapidly abraded, a problem arises in that the transport precision of the disc tray easily deteriorates.

### SUMMARY

An advantage of some aspects of the invention is that it provides a printing apparatus which is capable of more highly precisely correcting a skew of a transport object and of which a part of a transport device or the transport object is hardly abraded.

In order to achieve the above-described object, according to a first aspect of the invention, there is provided a printing apparatus for performing a printing process on a printing surface of a printing medium, the printing apparatus including: a transport device which transports a transport object having the printing medium loaded thereon in a predetermined transport direction; and a transport object locking portion which locks a movement of the transport object at a predetermined position on the upstream side or the downstream side of the transport direction, wherein a skewed posture of the transport object with respect to the transport direction is corrected in the state where the transport object is locked by the transport object locking portion.

With the above-described configuration, since it is possible to correct the skew of the transport object by moving the transport object up to the position where the transport object is locked by the transport object locking portion, it is possible to correct the skew of the transport object without alternately repeating the normal transport operation of the transport object and the reverse transport operation thereof using the transport device. Accordingly, it is possible to reduce the abrasion of the part of the transport device or the abrasion of the transport object as much as possible by correcting the skew of the transport object.

In addition, the movement of the transport object up to the position where the transport object is locked by the transport object locking portion may be realized by transporting the transport object using the transport device, or may be realized by allowing a user to manually insert the transport object into the printing apparatus.

Further, in the state where the transport object is locked by the transport object locking portion, the posture of the transport object is determined by the shape and the arrangement of the transport object locking portion. In other words, the shape and the arrangement of the transport object may be arbitrarily set as long as the posture of the transport object is substantially parallel to the transport direction in the state where the transport object is locked by the transport object locking portion. That is, the transport object locking portion according to the aspect of the invention has a high degree of freedom in the shape and the arrangement. Accordingly, it is not necessary to worry about the problem that the skew cannot be highly precisely corrected due to the limitation in which the shape and the arrangement of the transport object locking portion are limited by the structure or the like of the printing apparatus. In addition, it is not necessary to provide the large guide member as in the known technology.

Thus, in the printing apparatus according to the first aspect of the invention, it is advantageous in that it is possible to obtain the printing apparatus which is capable of more highly precisely correcting the skew of the transport object and of which the part of the transport device or the transport object is hardly abraded.

According to a second aspect of the invention, there is provided the printing apparatus according to the first aspect, wherein the transport object locking portion may include a first locking portion and a second locking portion which are distant from each other in a direction intersecting the transport direction, and wherein the skewed posture of the transport object with respect to the transport direction may be corrected in the state where the transport object is locked by the first locking portion and the second locking portion.

With the above-described configuration, in the state where the transport object is locked by the transport object locking portion, the posture of the transport object is corrected to be a reliably constant posture by the two-point support structure using the first and second locking portions which are distant from each other in a direction intersecting the transport direction. Accordingly, it is possible to realize the transport object locking portion which is capable of more highly precisely correcting the skew of the transport object.

According to a third aspect of the invention, there is provided the printing apparatus according to the first aspect, and the printing apparatus further includes: a control device which controls the transport device and a printing section, wherein the control device may transport the transport object up to a position where the transport object is locked by the transport object locking portion and may perform the printing process on the printing medium loaded on the transport object.

For example, in the printing apparatus having a structure in which the user manually inserts the transport object having the printing medium loaded thereon into the printing apparatus, the manually inserted transport object may be skewed due to the user's non-uniform manual insertion angle. Also, for example, in the printing apparatus having a structure in which the transport object is provided inside the printing apparatus and the transport object is automatically inserted and extracted by a button manipulation or the like, since the user's hand contacts with the transport object when the user loads the printing medium on the transport object, the transport object may be skewed.

For this reason, in this aspect of the invention, in the case of performing the printing process on the printing medium loaded on the transport object, it is desirable to perform the printing process in such a manner that the user performs the above-described manipulations by a hand, the transport object is transported up to the position where the transport object is locked by the transport object locking portion, and then the printing process is performed. Accordingly, it is possible to start the printing process to be performed on the printing medium loaded on the transport object after the skew of the transport object is reliably corrected. Therefore, it is possible to previously prevent the deterioration in the printing precision caused by the skew of the transport object.

According to a fourth aspect of the invention, there is provided the printing apparatus according to the third aspect, and the printing apparatus further includes: a skew detection section which detects a skew angle of the transport object with respect to the transport direction, wherein the control device may transport the transport object up to the position where the transport object is locked by the transport object locking portion and may perform the printing process on the printing medium loaded on the transport object only when the skew angle detected by the skew detection section of the transport object exceeds a predetermined angle.

As described above, in the case of transporting the transport object using the transport device, particularly, the part of the transport device or the transport object is easily abraded compared with the case of transporting the transport object such as the printing sheet. In addition, in the case of correcting the skew of the transport object by moving the transport object up to the position where the transport object is locked by the transport object locking portion, first, the transport object locking portion comes into point contact with a part of the transport object, rotation force about the contact point as a rotation center acts on the transport object, and then the skew of the transport object is corrected. At this time, since a sliding action occurs between the contact surfaces of the transport device and the transport object, the contact surfaces of the transport device and the transport object are abraded.

For this reason, in this aspect, in the case of performing the printing process on the printing medium loaded on the transport object, it is desirable to perform the printing process in such a manner that the transport object is transported up to the position where the transport object is locked by the transport object locking portion and the printing process is performed only when the skew angle of the transport object exceeds the predetermined angle. Accordingly, it is possible to perform the printing process on the printing medium loaded on the transport object after the skew of the transport object is reliably corrected by suppressing the abrasion of the transport object or the abrasion of the part of the transport device, caused by the operation of correcting the skew of the transport object, as much as possible. Therefore, it is possible to previously prevent the deterioration in the printing precision caused by the skew of the transport object and to further reduce the abrasion of the part of the transport device or the abrasion of the transport device.

For example, the predetermined angle may be set so that the skew angle of the transport object is within the allowable range capable of maintaining the constant printing precision with respect to the label surface of the printing medium.

According to a fifth aspect of the invention, there is provided a method of controlling the printing apparatus according to the first aspect, the method including: transporting the transport object up to a position where the transport object is locked by the transport object locking portion; and performing the printing process on the printing medium loaded on the transport object.

In the method of controlling the printing apparatus according to the fifth aspect of the invention, it is possible to obtain the same advantage as that of the printing apparatus according to the first, second, or third aspect of the invention.

### BRIEF DESCRIPTION OF THE DRAWINGS

The invention will be described with reference to the accompanying drawings, wherein like numbers reference like elements.

FIG. 1 is a plan view showing a schematic configuration of a main part of an ink jet printer according to a first embodiment.

FIG. 2 is a side view showing a schematic configuration of the main part of the ink jet printer according to the first embodiment.

FIG. 3 is a schematic block diagram showing the ink jet printer according to the first embodiment.

FIG. 4 is a plan view showing a configuration of a main part of a disc tray support device.

FIG. 5 is a plan view showing the main part of the ink jet printer according to the first embodiment.

FIG. 6 is a plan view showing the main part of the ink jet printer according to the first embodiment.

FIG. 7 is a plan view showing the main part of the ink jet printer according to the first embodiment.

FIG. 8 is a plan view showing the main part of the ink jet printer according to the first embodiment.

FIG. 9 is a perspective view showing the main part of the ink jet printer according to a second embodiment.

FIGS. 10A and 10B are enlarged perspective views showing a part provided with a first locking portion.

FIGS. 11A and 11B are perspective views showing a part provided with a second locking portion.

FIG. 12 is a perspective view showing the main part of the ink jet printer according to a third embodiment.

FIG. 13 is a perspective view showing the main part of the ink jet printer according to the third embodiment.

FIGS. 14A and 14B are enlarged perspective views showing a part provided with the first locking portion and the second locking portion.

### DESCRIPTION OF EXEMPLARY EMBODIMENTS

Hereinafter, exemplary embodiments of the invention will be described with reference to the accompanying drawings. In addition, the present invention is not limited to the embodiments to be described later, but may be modified into various forms without departing from the technical scope of the claims. The modified various forms are, of course, included in the scope of the invention.

### Ink Jet Printer According to First Embodiment of the Invention

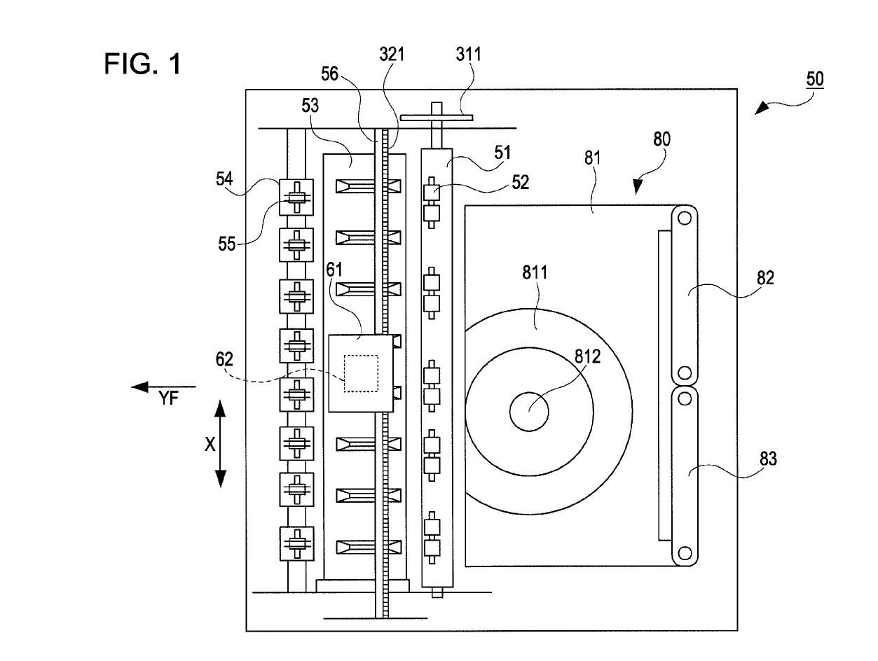

An ink jet printer 50 as “a printing apparatus” according to a first embodiment of the invention will be described with reference to FIGS. 1 to 8.

First, a schematic configuration of the ink jet printer 50 according to the first embodiment will be described with reference to FIGS. 1 to 3.

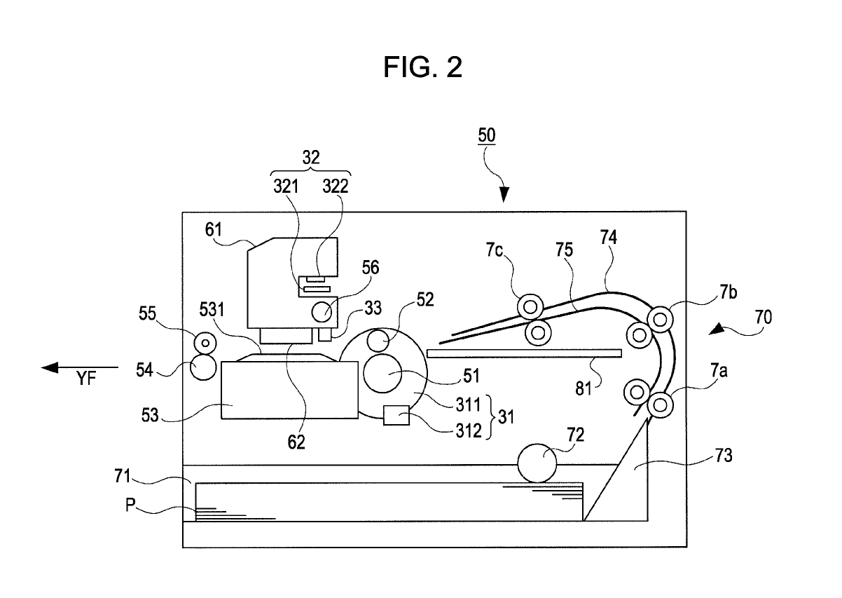

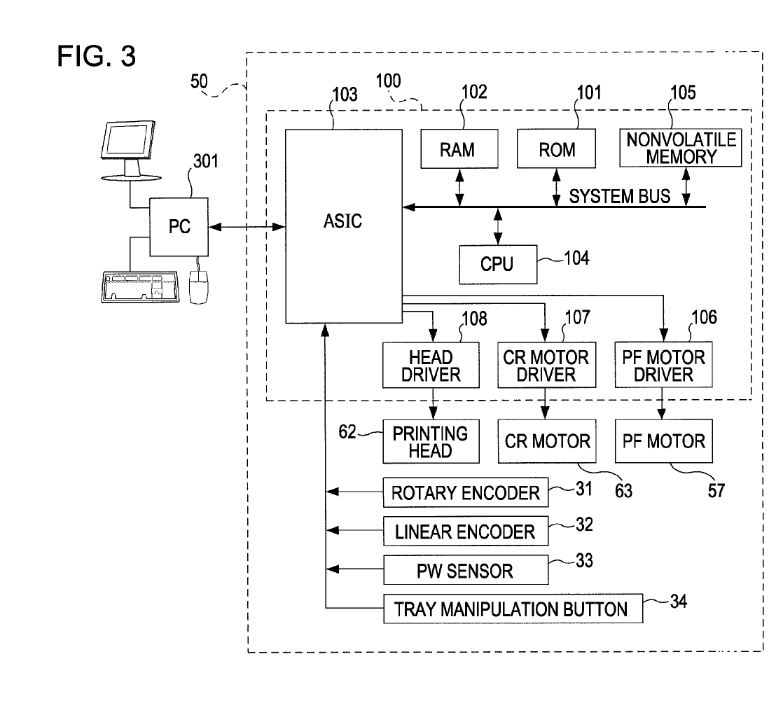

FIG. 1 is a plan view showing a main part of the ink jet printer 50. FIG. 2 is a side view showing the main part of the ink jet printer 50. FIG. 3 is a schematic block diagram showing the ink jet printer 50.

The ink jet printer 50 includes an automatic feeding device 70 which feeds a printing sheet P as “a printing medium” to the ink jet printer 50. In addition, the ink jet printer 50 includes a transport driving roller 51 and a transport driven roller 52 as “a transport device”. The ink jet printer 50 includes a printing head 62 as a member which performs a printing process by ejecting ink onto a printing surface of the printing sheet P supported to a platen 53. Further, the ink jet printer 50 includes a discharge driving roller 54 and a discharge driven roller 55 as members which transport the printing sheet P having been subjected to the printing process in a transport direction YF and discharge the printing sheet P.

The automatic feeding device 70 includes a feeding cassette 71, a feeding roller 72, a guide slope surface 73, feeding guide surfaces 74 and 75, and intermediate feeding roller pairs 7a, 7b, and 7c. The feeding cassette 71 accommodates plural printing sheets P in a piled state. The feeding roller 72 is rotated by rotational driving force of a PF motor 57. The feeding guide surfaces 74 and 75 form a curved feeding path as shown in the drawing. The guide slope surface 73 is a slope surface which guides the front end portion of the printing sheet P to a portion between the feeding guide surfaces 74 and 75. Each of the intermediate feeding roller pairs 7a, 7b, and 7c is a roller pair which includes a driving roller rotated by the rotational driving force of the PF motor 57 and a driven roller rotatably journaled to the driving roller.

The uppermost printing sheet P of the printing sheets P piled in the feeding cassette 71 comes into contact with the outer peripheral surface of the feeding roller 72, and is sent to a portion between the feeding guides surfaces 74 and 75 along the guide slope surface 73 by the rotation of the feeding roller 72. The printing sheet P sent to a portion between the feeding guide surfaces 74 and 75 along the guide slope surface 73 advances along the feeding path by the intermediate feeding roller pairs 7a, 7b, and 7c, and is fed to a position where the front end portion of the printing sheet P comes into contact with the transport driving roller 51 and the transport driven roller 52.

The surface of the transport driving roller 51 is coated to cause large friction, and the transport driving roller 51 is rotated by the rotational driving force of the PF motor 57. The transport driven roller 52 is journaled so as to rotate in a following manner, and is urged to the outer peripheral surface of the transport driving roller 51 by an urging member such as a spring (not shown) in a contact state. The printing sheet P fed by the automatic feeding device 70 is nipped between the transport driving roller 51 and the transport driven roller 52, and is transported onto the platen 53 by the driving rotation of the transport driving roller 51 in the transport direction YF.

The printing head 62 is disposed on a bottom portion of a carriage 61. A head surface of the printing head 62 is provided with plural ejection nozzles (not shown) which eject ink. The carriage 61 is supported to a carriage guide shaft 56 so as to be movable in a reciprocating manner in a width direction X (a direction intersecting the transport direction YF) in the state where the head surface of the printing head 62 is parallel to the printing surface of the printing sheet P transported onto the platen 53. The carriage 61 is connected to an endless belt (not shown) which is suspended a driving pulley (not shown) and a driven pulley (not shown) disposed in a rotary shaft of the CR motor 63. When the rotational driving force of the CR motor 63 is transmitted to the carriage 61 via the endless belt, the carriage 61 moves in a reciprocating manner in the width direction X.

The platen 53 includes plural platen ribs which are formed along the transport direction YF of the printing sheet P. The printing sheet P transported onto the platen 53 is supported in a direction from the front surfaces of the platen ribs to the rear surfaces thereof. The printing process is performed in such a manner that ink is ejected from the head surface of the printing head 62 onto the printing surface so as to form a dot in an area of the printing sheet P supported to the platen 53. A gap between the head surface of the printing head 62 and the printing surface of the printing sheet P is appropriately regulated by the top surfaces of the platen ribs.

The printing process is performed on the printing surface of the printing sheet P transported onto the platen 53 by alternately repeating an operation of forming a dot by ejecting ink from the head surface of the printing head 62 onto the printing surface of the printing sheet P in the state where the carriage 61 moves in a reciprocating manner in the width direction X and an operation of transporting the printing sheet P by a predetermined transport amount in the transport direction YF by the driving rotation of the transport driving roller 51. The printing sheet P having ink ejected thereon is nipped by the discharge driving roller 54 and the discharge driven roller 55, and is discharged in the transport direction YF by the driving rotation of the discharge driving roller 54. A series of the printing control is performed by a printing controller 100 as “a control device” including a micro computer control circuit.

The printing controller 100 includes a ROM 101, a RAM 102, an ASIC (Application Specific IC) 103, a CPU (Central Processing Unit) 104, a nonvolatile memory 105, a PF motor driver 106, a CR motor driver 107, and a head driver 108.

The ROM 101 stores a printing control program (firm ware) required for an operation of controlling the ink jet printer 50 using the CPU 104. The RAM 102 is used as a work area of the CPU 104 or a storage area of image data or the like. The CPU 104 performs a calculation process for performing the printing control of the ink jet printer 50 or other required calculation processes by performing the printing control program. The nonvolatile memory 105 stores various data required for the calculation process using the printing control program. The ASIC 103 performs various calculations for performing a speed control of the PF motor 57 and the CR motor 63, and transmits a motor control signal based on the calculation result to the PF motor driver 106 and the CR motor driver 107. In addition, the ASIC 103 creates a control signal of the printing head 62 by means of a calculation and transmits the control signal to the head driver 108, thereby controlling an ink ejection operation of the printing head 62. Further, the ASIC 103 has an interface function with respect to a personal computer 301.

A rotary encoder 31 which detects the rotation amount of the transport driving roller 51 includes a rotary scale 311 and a rotary scale sensor 312. The rotary scale 311 is formed such that plural slits are concentrically formed along the outer periphery at the same interval therebetween, and rotates together with the rotation of the transport driving roller 51. The rotary scale sensor 312 is a sensor which detects the slits of the rotary scale 311. The output signal of the rotary scale sensor 312 changing with the rotation of the transport driving roller 51 is output to the CPU 104 via the ASIC 103.

A linear encoder 32 which detects the movement amount of the carriage 61 includes a linear scale 321 and a linear scale sensor 322. The linear scale 321 is disposed in the vicinity of the carriage 61 so as to be substantially parallel to the width direction X, and has plural slits formed at the same interval therebetween. The linear scale sensor 322 is a sensor which detects the slits of the linear scale 321, and is mounted on the carriage 61. In the output signal of the linear scale sensor 322, a cycle of pulses in accordance with the movement amount of the carriage 61 in the width direction X changes with the movement speed of the carriage 61. The output signal is output to the CPU 104 via the ASIC 103.

A PW sensor 33 which detects the printing sheet P is a non-contact optical sensor, and is disposed in the bottom portion of the carriage 61. A tray manipulation button 34 is a button which allows a user to manipulate the disc tray support device 80. The detection signal of the PW sensor 33 and the manipulation signal of the tray manipulation button 34 are output to the CPU 104 via the ASIC 103.

In addition, the ink jet printer 50 includes the disc tray support device 80. The disc tray support device 80 includes a disc tray 81, a left support arm 82, and a right support arm 83. The disc tray 81 as “a transport object” is supported to the left support arm 82 and the right support arm 83 so as to be movable in the transport direction YF, and includes a loading portion 811 which is used to load an optical disc thereon. The loading portion 811 is provided with a convex portion 812 which is fitted to a central hole of the optical disc.

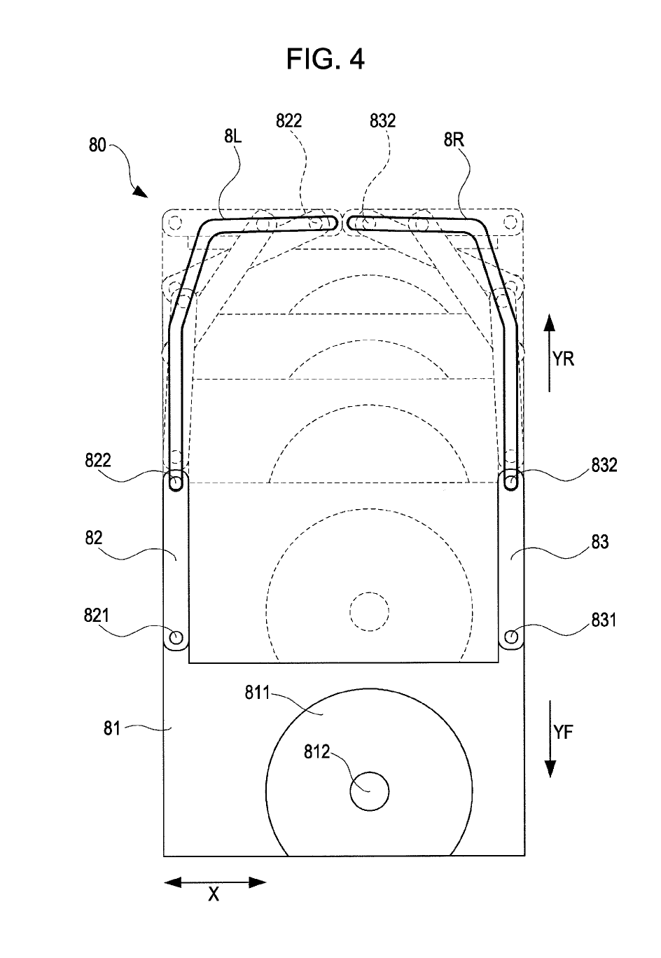

Hereinafter, the configuration of the disc tray support device 80 will be described in detail with reference to FIG. 4.

FIG. 4 is a plan view showing the configuration of the main part of the disc tray support device 80.

A convex portion 821 provided in one end of the left support arm 82 is pivotally connected to the disc tray 81, and a convex portion 822 provided in the other end thereof engages with a left guide groove 8L. The left guide groove 8L is provided on the rear surface of the member forming the feeding guide surface 75 (FIG. 2). A convex portion 831 provided on one end of the right support arm 83 is pivotally connected to the disc tray 81, and a convex portion 832 provided in the other end thereof engages with a right guide groove 8R. The right guide groove 8R is provided in a tray support plate (not shown) which supports the bottom portion of the disc tray 81.

In the disc tray support device 80 with the above-described configuration, the left support arm 82 and the right support arm 83 are folded (so as to take a posture substantially parallel to the width direction X) in the state where the disc tray 81 is located on the most reverse transport direction YR. In addition, when the disc tray 81 moves in the transport direction YF in this state, the left support arm 82 displaces along the left guide groove 8L in a rotating manner, and the right support arm 83 displaces along the right guide groove 8R in a rotating manner. By means of the support structure having the above-described configuration, the disc tray support device 80 is capable of supporting the disc tray 81 so as to be movable in the transport direction YF and the reverse transport direction YR along a movement range larger than the length of the disc tray 81 in the transport direction YF. Accordingly, it is possible to move the disc tray 81 provided on the rear side of the ink jet printer 50 so as to protrude from a discharge opening on the front side of the ink jet printer 50 (on the downstream side of the discharge driving roller 54 in the transport direction YF) to a position comparatively distant from the discharge opening. Further, since the size of the disc tray 81 can be decreased as much as possible, it is possible to prevent an increase in size of the ink jet printer 50 provided with the disc tray 81.

Further, the movement of the disc tray 81 in the transport direction YF is locked when the convex portion 822 of the left support arm 82 collides with the most downstream end (first locking portion) of the inner wall surface of the left guide groove 8L, and the convex portion 832 of the right support arm 83 collides with the most downstream end (second locking portion) of the inner wall surface of the right guide groove 8R (transport object locking portion). In the disc tray support device 80, the shapes of the left support arm 82, the right support arm 83, the left guide groove 8L, and the right guide groove 8R are set so that the posture of the disc tray 81 is substantially parallel to the transport direction YF.

That is, in the ink jet printer 50 according to the invention, since the disc tray 81 is transported in the transport direction YF up to a position where the movement of the disc tray 81 is locked, it is possible to correct the posture of the disc tray 81 so as to be substantially parallel to the transport direction YF in the case where the disc tray 81 is skewed with respect to the transport direction YF. Accordingly, it is possible to reduce the transport amount of the disc tray 81 upon correcting the skew of the disc tray 81 compared with the case of the known printing apparatus, and thus to minimize abrasion of the transport driving roller 51 or abrasion of the disc tray 81 caused by the operation of correcting the skew of the disc tray 81.

Likewise, according to the invention, the transport driving roller 51 or the disc tray 81 is hardly abraded. In addition, it is possible to realize the printing apparatus capable of highly precisely correcting the skew of the disc tray 81.

### Transport Control of Disc Tray 81 According to First Embodiment

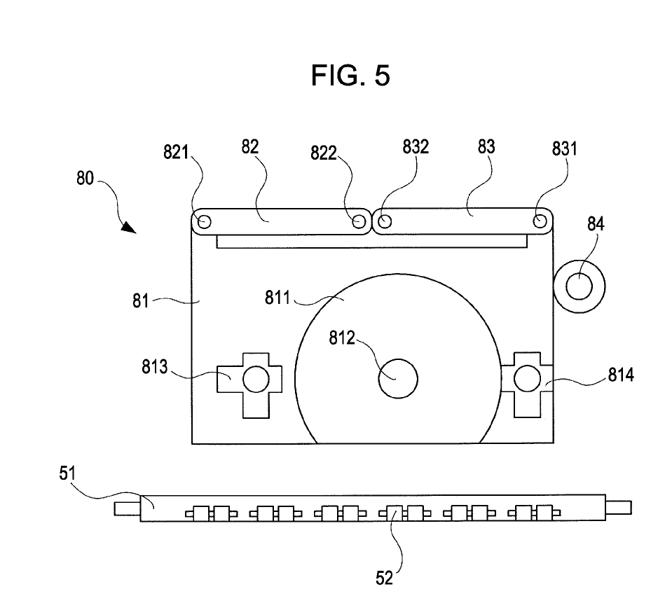

Next, the transport control of the disc tray 81 using the printing controller 100 according to the first embodiment will be described with reference to FIGS. 5 to 8.

FIGS. 5 to 8 are plan views showing the main part of the ink jet printer 50.

The ink jet printer 50 includes a rotary gear 84. The rotary gear 84 is rotated in both directions by rotational driving force of an exclusive motor (not shown) of which the rotation is controlled by the printing controller 100. A gear portion of the rotary gear 84 meshes with a gear portion (not shown) which is provided in the side portion of the disc tray 81.

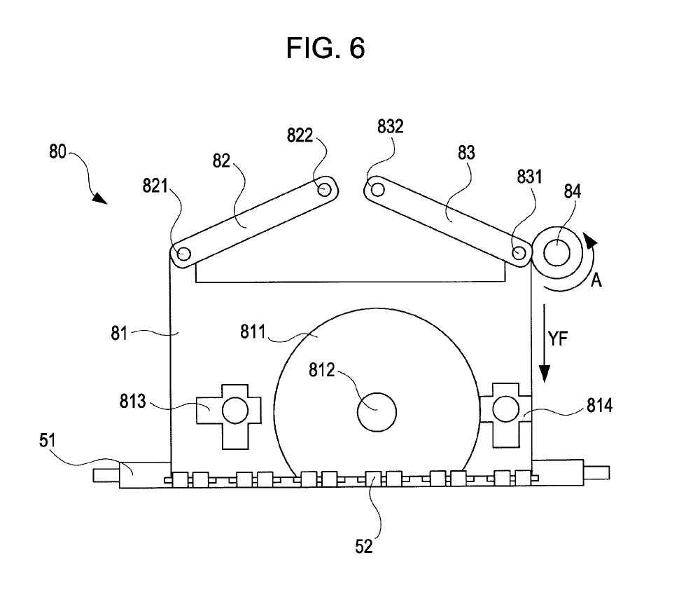

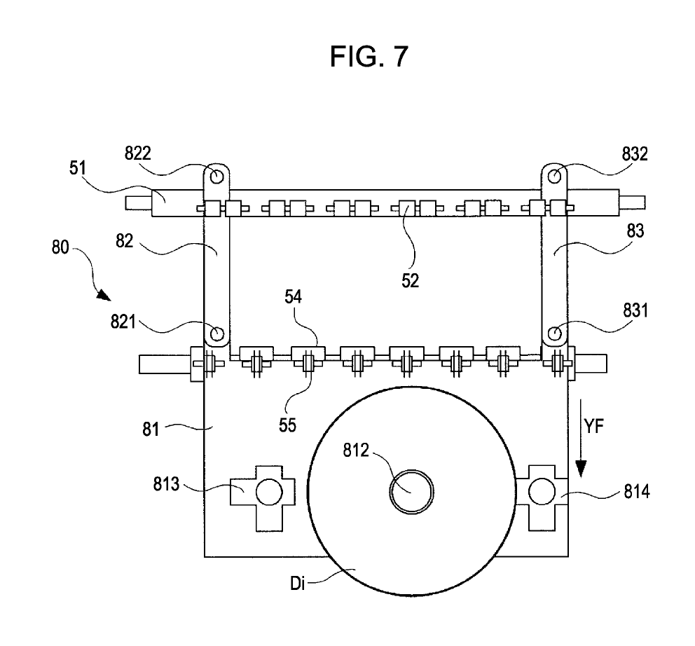

When the tray manipulation button 34 is pushed in the state where the disc tray 81 is located at a standby position (FIG. 5), first, the printing controller 100 rotates the rotary gear 84 in a rotation direction depicted by “A”. Accordingly, the disc tray 81 moves to a position where the front end portion thereof in the transport direction YF collides with a portion where the transport driving roller 51 and the transport driven roller 52 come into contact with each other, and a portion in the vicinity of the front end portion is nipped by the transport driving roller 51 and the transport driven roller 52 (See FIG. 6). In this state, the printing controller 100 rotates the transport driving roller 51 in a rotation direction in which the disc tray 81 is transported in the transport direction YF (hereinafter, referred to as “a normal rotation direction”). Accordingly, the disc tray 81 is transported in the transport direction YF by the rotation of the transport driving roller 51, and protrudes from the discharge opening on the front side of the ink jet printer 50 (FIG. 7). In this state, the user is capable of loading an optical disc Di as “a printing medium” on the loading portion 811 of the disc tray 81 of the ink jet printer 50.

When the tray manipulation button 34 is manipulated again in this state, the printing controller 100 further rotates the transport driving roller 51 in the normal rotation direction so that the disc tray 81 is transported in the transport direction YF up to a position where the movement of the disc tray 81 is locked in the transport direction YF. Accordingly, for example, when the disc tray 81 is skewed by the user's hand during an operation in which the user loads the optical disc Di on the disc tray 81, it is possible to correct the posture of the disc tray 81 so as to be substantially parallel to the transport direction YF.

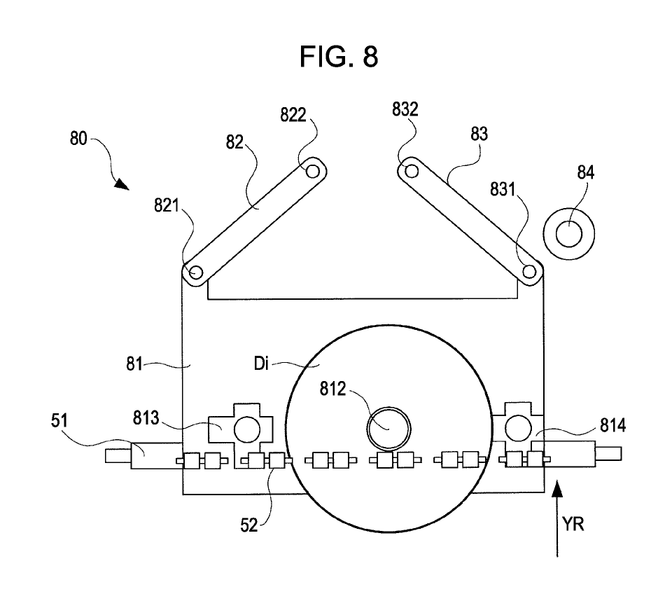

Subsequently, the printing controller 100 rotates the transport driving roller 51 in a rotation direction in which the tray 81 is transported in the reverse transport direction YR (hereinafter, referred to as “a reverse rotation direction”). Accordingly, the disc tray 81 is transported in the reverse transport direction YR by the rotation of the transport driving roller 51. Then, the printing controller 100 stops the rotation of the transport driving roller 51 at a time point when the disc tray 81 is reversely transported to a predetermined position. Accordingly, the disc tray 81 stops at a position where a label surface of the optical disc Di is located at a predetermined printing start position, thereby performing the printing process on the label surface of the optical disc Di in accordance with a control sequence which is the same as that of the operation of performing the printing process on the printing sheet P (FIG. 8).

In this state, the printing controller 100 detects the existence of the optical disc Di and the loading position thereof by using the PW sensor 33. In the case where the optical disc Di is correctly loaded on the loading portion 811, the printing control of controlling the printing process performed on the label surface of the optical disc Di starts. On the other hand, in the case where the optical disc Di is not detected, the disc tray 81 is reversely transported up to the standby position (FIG. 5). In the case where the loading state of the optical disc Di is not correct, an error display or the like is performed.

After the printing process performed on the label surface of the optical disc Di ends, the printing controller 100 transports the disc tray 81 in the transport direction YF up to a position where the disc tray 81 protrudes from the discharge opening on the front side of the ink jet printer 50 (FIG. 7). In this state, the user is capable of separating the optical disc Di having been subjected to the printing process from the loading portion 811 of the disc tray 81 of the ink jet printer 50. Then, when the tray manipulation button 34 is pushed again, the printing controller 100 reversely transports the disc tray 81 to the standby position (FIG. 5).

Likewise, when the printing process is performed on the optical disc Di loaded on the disc tray 81 of the ink jet printer 50 according to the invention, the printing process may be performed in such a manner that the user loads the optical disc Di on the disc tray 81, the disc tray 81 is transported in the transport direction YF up to the position where the movement of the disc tray 81 in the transport direction YF is locked, and the posture of the disc tray 81 is corrected. Accordingly, after the skew of the disc tray 81 is reliably corrected, it is possible to perform the printing process on the label surface of the optical disc Di loaded on the disc tray 81. Therefore, it is possible to previously prevent the deterioration in the printing precision caused by the skew of the disc tray 81.

Further, in the embodiment, when the tray manipulation button 34 is first pushed in the state where the disc tray 81 is located at the standby position (FIG. 5), the disc tray 81 may be transported from the standby position to the position where the movement of the disc tray 81 in the transport direction YF is locked without stopping between the positions.

### Transport Control of Disc Tray 81 According to Second Embodiment

Next, the transport control of the disc tray 81 using the printing controller 100 according to a second embodiment will be described with reference to FIGS. 5 to 8.

The control sequence until the disc tray 81 protrudes from the discharge opening on the front side of the ink jet printer 50 (FIG. 7) is the same as that of the first embodiment. In this state, when the tray manipulation button 34 is pushed again, the printing controller 100 according to the second embodiment reversely transports the disc tray 81 up to a predetermined printing start position without performing the operation of correcting the skew of the disc tray 81 (FIG. 8). In this state, when the carriage 61 moves in a reciprocating manner in the width direction X, the PW sensor 33 as “a skew detection section” loaded on the carriage 61 is capable of scanning and detecting a first detection mark 813 and a second detection mark 814 provided in the disc tray 81.

The first detection mark 813 and the second detection mark 814 are detection marks which are used to highly precisely specify the central position of the optical disc Di loaded on the disc tray 81 located at the printing start position, and detection marks which highly precisely specify a skew angle (a skew angle with respect to the transport direction YF) of the disc tray 81. The disc tray 81 is formed of black plastic. The first detection mark 813 and the second detection mark 814 are formed by painting white on the surface of the disc tray 81. In addition, as shown in the drawing, a circular perforation hole is formed at each of the center portions of the first detection mark 813 and the second detection mark 814.

While an operation of moving the carriage 61 in the width direction X and an operation of transporting the disc tray 81 in the transport direction YF or the reverse transport direction YR are performed by the printing controller 100, the PW sensor 33 scans and detects the positions of the left and right ends (both ends in the width direction X) and the upper and lower ends (the upstream and downstream ends in the transport direction YF) of each of the perforation hole of the first detection mark 813 and the perforation hole of the second detection mark 814. It is possible to specify the positions on the basis of the transport position of the disc tray 81 based on the output signal of the rotary encoder 31, the position of the carriage 61 based on the output signal of the linear encoder 32, and the output signal output from the PW sensor 33.

The printing controller 100 specifies the central point position of the perforation hole of the first detection mark 813 on the basis of the left and right ends and the upper and lower ends of the perforation hole of the first detection mark 813, and specifies the central point position of the perforation hole of the second detection mark 814 on the basis of the positions of the left and right ends and the upper and lower ends of the second detection mark 814. Subsequently, the printing controller 100 specifies the central position of the optical disc Di loaded on the disc tray 81 on the basis of the specified central point position of the perforation hole of the first detection mark 813 and the specified central point position of the perforation hole of the second detection mark 814, and specifies the skew angle of the disc tray 81 with respect to the transport direction YF.

When the skew angle of the disc tray 81 with respect to the transport direction YF exceeds a predetermined angle, the printing controller 100 rotates the transport driving roller 51 in the normal rotation direction so as to transport the disc tray 81 up to a position where the movement of the disc tray 81 in the transport direction YF is locked. Accordingly, it is possible to correct the posture of the disc tray 81 so as to be substantially parallel to the transport direction YF. After the posture of the disc tray 81 is corrected, the printing controller 100 reversely transports the disc tray 81 so that the label surface of the optical disc Di is located at a predetermined printing start position (FIG. 8), and starts the printing process to be performed on the label surface of the optical disc Di.

On the other hand, when the skew angle of the disc tray 81 with respect to the transport direction YF is not more than the predetermined angle, the printing controller 100 starts the printing process to be performed on the label surface of the optical disc Di without transporting the disc tray 81 in the transport direction YF up to a position where the movement of the disc tray 81 is locked in the transport direction YF.

For example, the predetermined angle may be set so that the skew angle of the disc tray 81 is within the allowable range capable of maintaining the constant printing precision with respect to the label surface of the optical disc Di. In addition, in the case where any one of the first detection mark 813 and the second detection mark 814 is not correctly detected, it is determined that the disc tray 81 is largely skewed. In this case, the control for correcting the posture of the disc tray 81 may be controlled, or an error display or the like may be used to inform the error after stopping the printing control. Further, since the control sequence based on the existence of the optical disc Di and the loading position thereof and the control sequence after performing the printing process on the label surface of the optical disc Di are the same as those of the first embodiment, the description thereof will be omitted.

Likewise, in the ink jet printer 50 according to the invention, it is more desirable to adopt such a configuration in which the disc tray 81 is transported in the transport direction YF up to a position where the movement of the disc tray 81 in the transport direction YF is locked and the printing process is performed on the label surface of the optical disc Di after correcting the skew of the disc tray 81 only when the skew angle of the disc tray 81 with respect to the transport direction YF detected by the PW sensor 33 exceeds the predetermined angle. Accordingly, it is possible to perform the printing process on the label surface of the optical disc Di loaded on the disc tray 81 after the skew of the disc tray 81 is reliably corrected by suppressing the abrasion of the transport driving roller 51 or the abrasion of the disc tray 81, caused by the operation of correcting the skew of the disc tray 81, as much as possible. Therefore, it is possible to previously prevent the deterioration in the printing precision caused by the skew of the disc tray 81 and to further reduce the abrasion of the transport driving roller 51 or the abrasion of the disc tray 81.

### Ink Jet Printer According to Second Embodiment

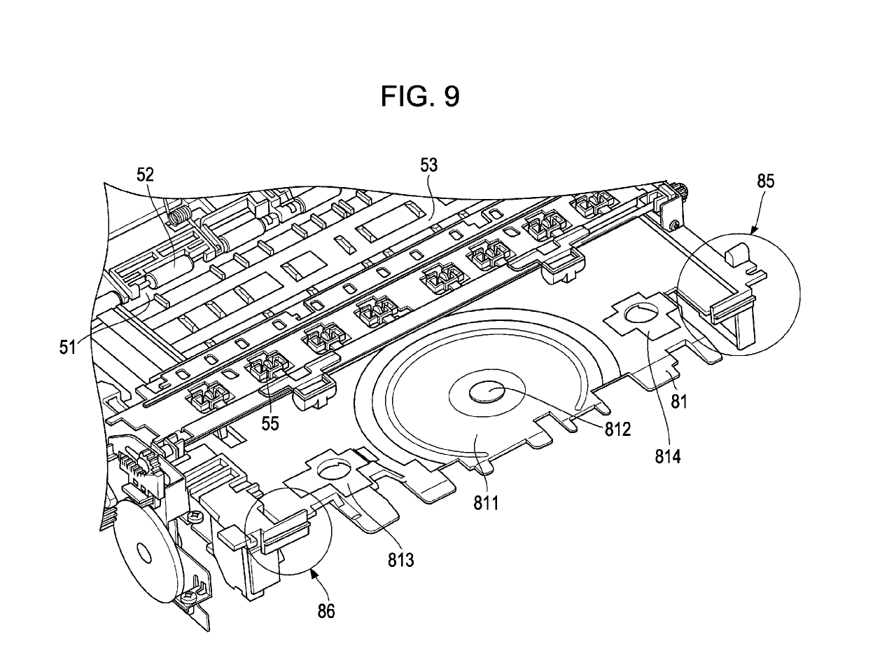

The ink jet printer 50 according to the second embodiment of the invention will be described with reference to FIGS. 9 to 11.

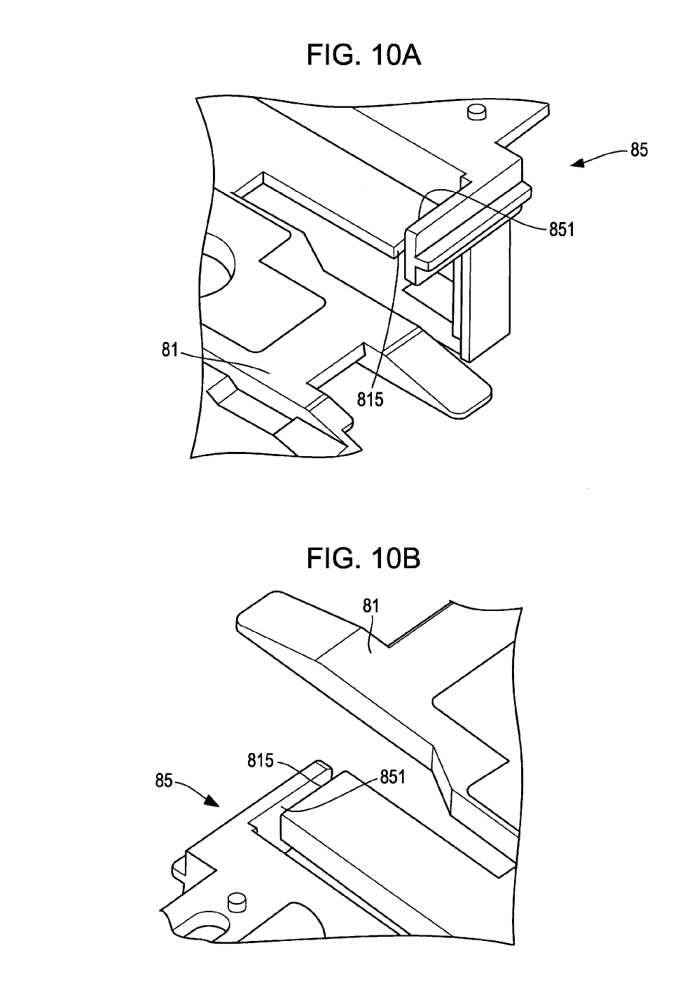

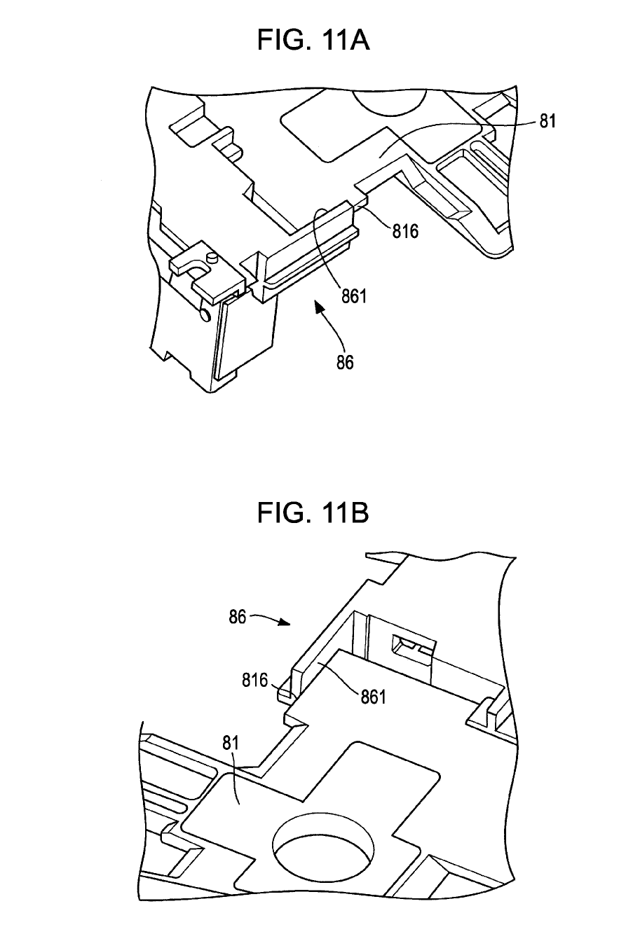

FIG. 9 is a perspective view showing the main part of the ink jet printer 50 according to the second embodiment of the invention, where the disc tray 81 protrudes from the discharge opening. FIGS. 10A and 10B are enlarged perspective views showing a part provided with a first locking portion 85. FIGS. 11A and 11B are enlarged perspective views showing a part provided with a second locking portion 86.

In the ink jet printer 50 according to the second embodiment, the first locking portion 85 and the second locking portion 86 as “transport object locking portions” are provided in the vicinity of the discharge opening. That is, the ink jet printer 50 according to the second embodiment includes the disc tray support device 80 having the same structure as that of the first embodiment. However, the most downstream end of the inner wall surface of the left guide groove 8L and the most downstream end of the inner wall surface of the right guide groove 8R do not serve as “the transport object locking portions”. In the ink jet printer 50 according to the second embodiment, the movement of the disc tray 81 in the transport direction YF is locked when a wall surface 851 of the first locking portion 85 and a wall surface 861 of the second locking portion 86 collide with a front end portion 815 of the disc tray 81 in the transport direction YF. Further, the wall surface 851 of the first locking portion 85 and the wall surface 861 of the second locking portion 86 are provided so that the posture of the disc tray 81 is corrected to be substantially parallel to the transport direction YF.

Further, since the other configurations which are not described above are the same as those of the ink jet printer 50 according to the first embodiment, the description thereof will be omitted.

### Ink Jet Printer According to Third Embodiment of the Invention

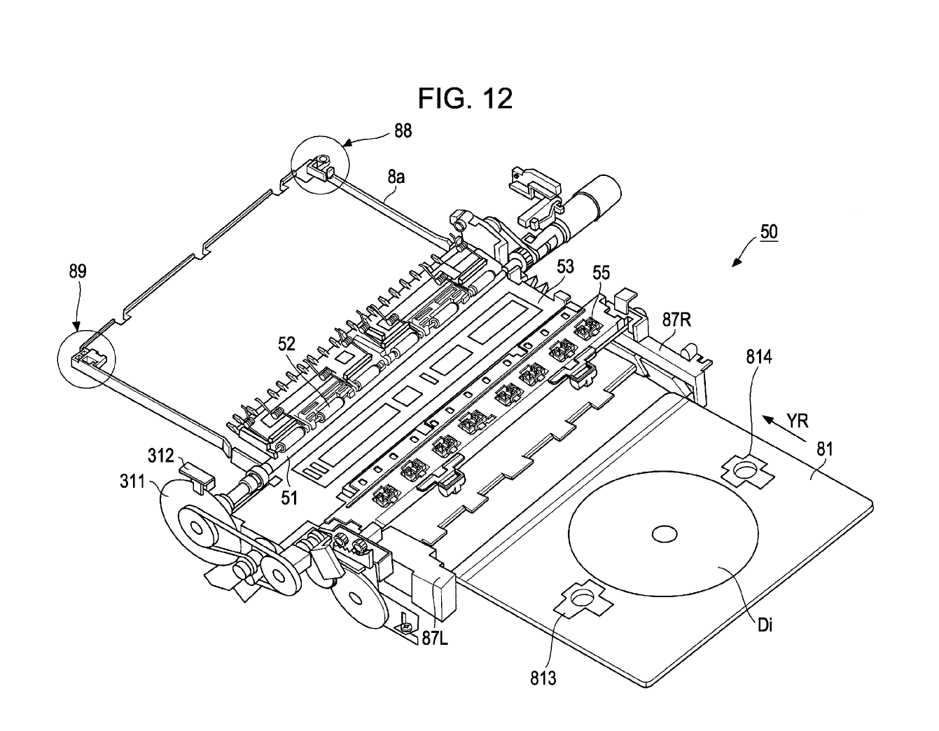

The ink jet printer according to a third embodiment of the invention will be described with reference to FIGS. 12 to 14.

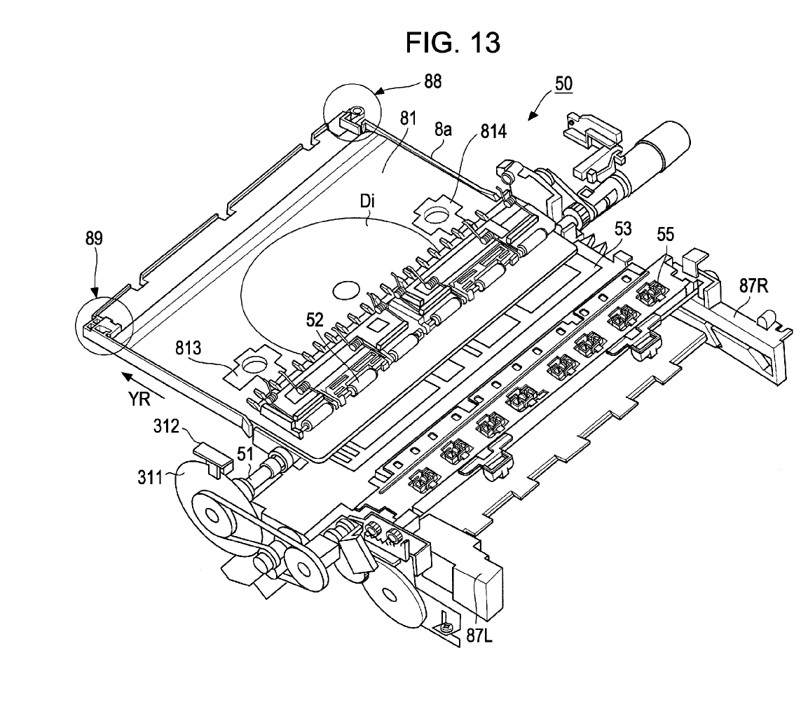

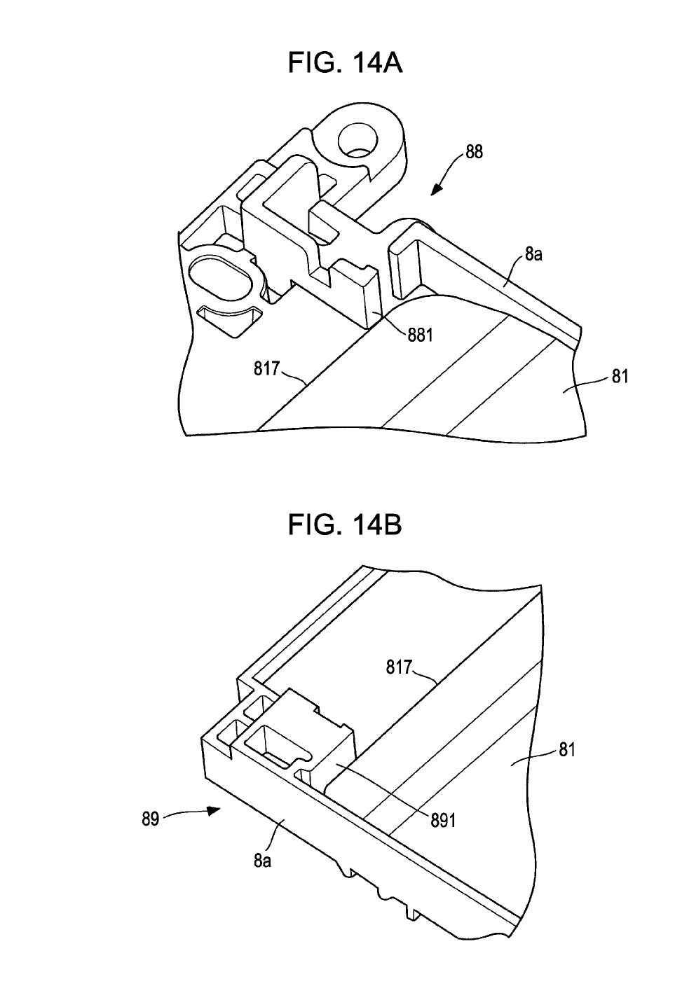

FIGS. 12 and 13 are perspective views showing the main part of the ink jet printer 50 according to the third embodiment. FIGS. 14A and 14B are enlarged perspective views showing a part provided with a first locking portion 88 and a part provided with a second locking portion 89.

The ink jet printer 50 according to the third embodiment is a printing apparatus having a structure in which the disc tray 81 is not provided and the disc tray 81 having the optical disc Di loaded thereon is manually inserted into the printing apparatus to be fed by the user. For this reason, the disc tray support device 80 is not provided. Further, in order to reliably and smoothly perform an operation in which the disc tray 81 is manually inserted into the printing apparatus by the user, a left guide portion 87L and a right guide portion 87R are provided in the vicinity of the discharge opening. A tray support plate 8a is provided on the upstream side of the transport driving roller 51 in the transport direction YF so as to support the bottom portion of the disc tray 81. The ink jet printer 50 according to the third embodiment includes the first locking portion 88 and the second locking portion 89 as “the transport object locking portions” which are provided on the upstream end of the tray support plate 8a in the transport direction YF.

In the ink jet printer 50 according to the third embodiment, the movement of the disc tray 81 in the reverse transport direction YR is locked when a wall surface 881 of the first locking portion 88 and a wall surface 891 of the second locking portion 89 collide with a front end portion 817 of the disc tray 81 in the reverse transport direction YR. In addition, the wall surface 881 of the first locking portion 88 and the wall surface 891 of the second locking portion 89 are provided so that the posture of the disc tray 81 is corrected so as to be substantially parallel to the transport direction YF.

Further, since the other configurations which are not described above are the same as those of the ink jet printer 50 according to the first embodiment, the description thereof will be omitted.

In the ink jet printer 50 having the above-described configuration, in the case of performing the printing process on the label surface of the optical disc Di, first, the user manually inserts the disc tray 81 having the optical disc Di loaded thereon from the discharge opening to a predetermined insertion position in the reverse transport direction YR. When the user pushes the tray manipulation button 34 after manually inserting the disc tray 81 into the printer, the printing controller 100 rotates the transport driving roller 51 in the reverse rotation direction so as to reversely transport the disc tray 81 up to a position where the wall surface 881 of the first locking portion 88 and the wall surface 891 of the second locking portion 89 collide with the front end portion 817 of the disc tray 81 in the reverse transport direction YR (FIGS. 13 and 14). Accordingly, in the case where the disc tray 81 manually inserted by the user is skewed, it is possible to correct the posture of the disc tray 81 so as to be substantially parallel to the transport direction YF.

Subsequently, the printing controller 100 rotates the transport driving roller 51 in the normal rotation direction. Accordingly, the disc tray 81 is transported in the transport direction YF by the rotation of the transport driving roller 51. Then, the printing controller 100 stops the rotation of the transport driving roller 51 at a time point when the disc tray 81 is transported up to a predetermined position. Accordingly, the disc tray 81 stops at a position where the label surface of the optical disc Di is located at a predetermined printing start position. Therefore, it is possible to perform the printing process on the label surface of the optical disc Di in accordance with the same control sequence as that of the printing process performed on the printing sheet P.

Further, in the ink jet printer 50 according to the third embodiment, the disc tray 81 may be transported in the reverse transport direction YR up to a position where the disc tray 81 is locked by the first locking portion 88 and the second locking portion 89 only when the skew angle of the disc tray 81 exceeds a predetermined angle. The skew angle of the disc tray 81 may be specified by the first detection mark 813 and the second detection mark 814 provided in the disc tray 81 in accordance with the same sequence as that of the transport control of the disc tray 81 according to the second embodiment.

Further, in the ink jet printer 50 according to the third embodiment, the user may manually insert the disc tray 81 up to a position where the disc tray 81 is locked by the first locking portion 88 and the second locking portion 89.

What is claimed is:

1. A printing apparatus for performing a printing process on a printing surface of a printing medium, the printing apparatus comprising:
a transport device which transports a transport object having the printing medium loaded thereon in a predetermined transport direction; and
a transport object locking portion which locks a movement of the transport object at a predetermined position on the upstream side or the downstream side of the transport direction,
wherein a skewed posture of the transport object with respect to the transport direction is corrected in the state where the transport object is locked by the transport object locking portion.

2. The printing apparatus according to claim 1,
wherein the transport object locking portion includes a first locking portion and a second locking portion which are distant from each other in a direction intersecting the transport direction, and
wherein the skewed posture of the transport object with respect to the transport direction is corrected in the state where the transport object is locked by the first locking portion and the second locking portion.

3. The printing apparatus according to claim 1, further comprising:
a control device which controls the transport device and a printing section,
wherein the control device transports the transport object up to a position where the transport object is locked by the transport object locking portion and performs the printing process on the printing medium loaded on the transport object.

4. The printing apparatus according to claim 3, further comprising:
a skew detection section which detects a skew angle of the transport object with respect to the transport direction,
wherein the control device transports the transport object up to the position where the transport object is locked by the transport object locking portion and performs the printing process on the printing medium loaded on the transport object only when the skew angle detected by the skew detection section of the transport object exceeds a predetermined angle.

5. A method of controlling the printing apparatus according to claim 1, the method comprising:
transporting the transport object up to a position where the transport object is locked by the transport object locking portion; and
performing the printing process on the printing medium loaded on the transport object.
